(19) United States
(12) Patent Application Publication
(10) Pub. No.: US 2015/0137584 A1
(43) Pub. Date: May 21, 2015

(54) Rim for Tubeless Tire

(71) Applicant: JALCO INDUSTRY CO., LTD., Changhua Hsien (TW)

(72) Inventor: Han-Tsung Chen, Changhua Hsien (TW)

(73) Assignee: JALCO INDUSTRY CO., LTD., Changhua Hsien (TW)

(21) Appl. No.: 14/154,320

(22) Filed: Jan. 14, 2014

(30) Foreign Application Priority Data
Nov. 19, 2013 (TW) 102221554

(51) Int. Cl. B60B 21/10

(52) U.S. Cl. CPC B60B 21/108; B60B 2900/523; B60B 2900/325
USPC 301/95.101

(57) ABSTRACT

A rim includes two annular walls. Each of the annular walls includes an edge, an internal face, and at least one rib extending on the internal face near the edge. The rib of each of the annular walls of the rim bites an external face of a corresponding annular wall of a tubeless tire when the tubeless tire is mounted on the rim.

### BACKGROUND OF INVENTION

1. Field of Invention

The present invention relates to a wheel of a bicycle and, more particularly, to a rim for a tubeless tire.

2. Related Prior Art

There are rims for tubeless tires. Such a rim includes an internal face for air-tight contact with an external face of a tubeless tire. Normally, the friction between the internal face of the rim and the external face of the tubeless tire is sufficient to firmly mount the tubeless tire on the rim. However, the tire would be detached from the rim when the tire tilts and/or hits something.

The present invention is therefore intended to obviate or at least alleviate the problem encountered in the prior art.

### SUMMARY OF INVENTION

It is the primary objective of the present invention to provide a rim for a tubeless tire.

To achieve the foregoing objective, the rim includes two annular walls. Each of the annular walls includes an edge, an internal face, and at least one rib extending on the internal face near the edge. A rim includes two annular walls. Each of the annular walls includes an edge, an internal face, and at least one rib extending on the internal face near the edge. The rib of each of the annular walls of the rim bites an external face of a corresponding annular wall of a tubeless tire when the tubeless tire is mounted on the rim.

In an aspect, the rib extends in an annular manner.

In another aspect, each of the annular walls includes a plurality of ribs on the internal face.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a partial perspective view of a rim according to the first embodiment of the present invention;

FIG. 2 is a cross-sectional view of a tubeless tire mounted on the rim shown in FIG. 1;

FIG. 3 is an enlarged partial view of the tubeless tire and rim shown in FIG. 2;

FIG. 4 is a cross-sectional view of the tubeless tire and rim in another position shown in FIG. 2;

FIG. 5 is a cross-sectional view of a rim according to the second embodiment of the present invention; and

FIG. 6 is an enlarged partial view of the tubeless tire shown in FIG. 5.

### DETAILED DESCRIPTION OF PREFERRED EMBODIMENT

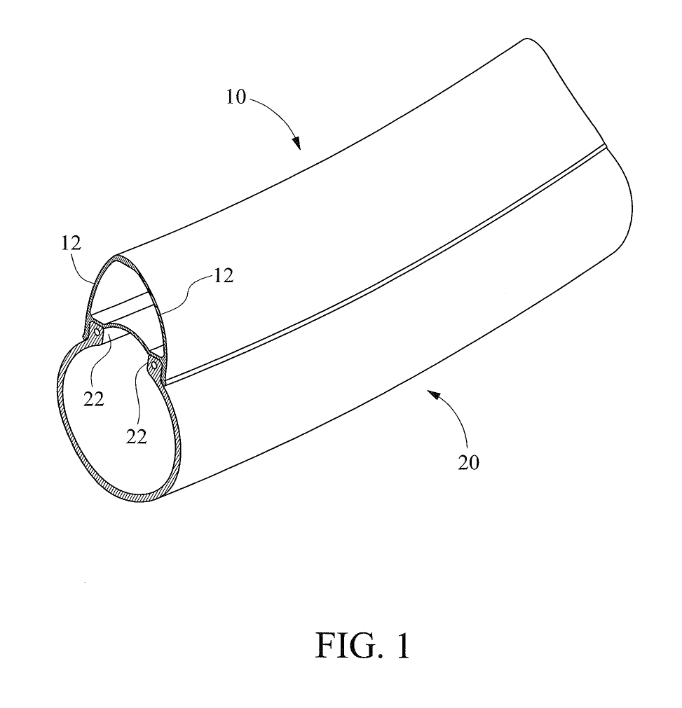

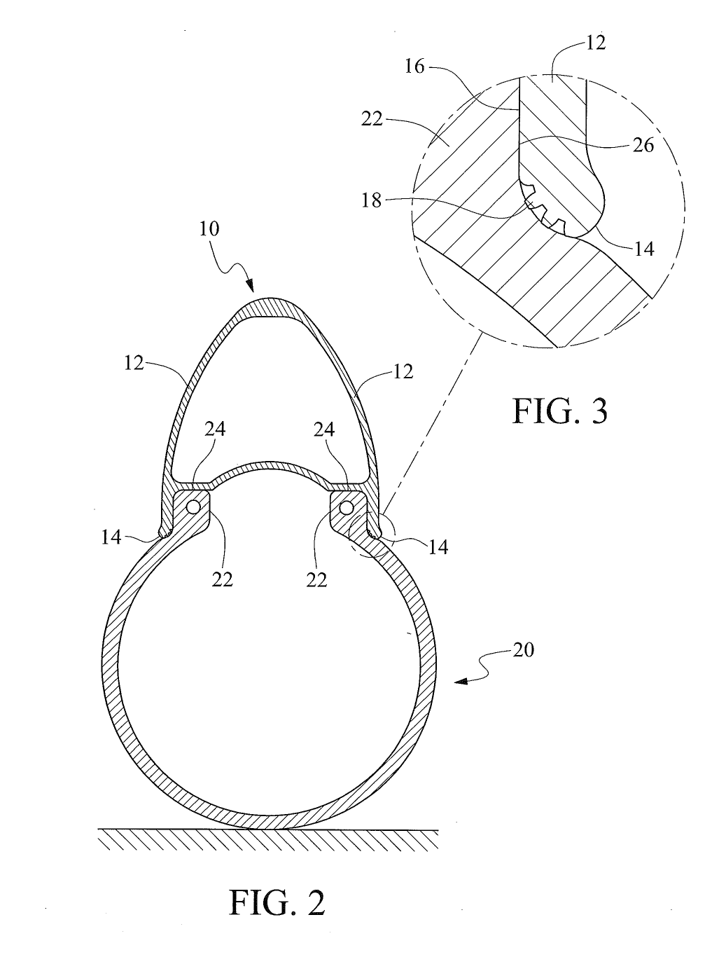

Referring to FIGS. 1 through 3, there is a rim 10 according to a first embodiment of the present invention. The rim 10 includes two annular walls 12. Each of the annular walls 12 is formed with an edge 14, an internal face 16, and annular ribs 18 extending on the internal face 16 near the edge 14. The annular ribs 18 can extend beyond the internal face 16. Alternatively, the annular ribs 18 can be flush with the internal face 16, i.e., the annular ribs 18 are made by cutting grooves in the internal face 16.

A tubeless tire 20 includes two annular walls 22. Each of the annular walls 22 includes an edge 24 and an external face 26. The tubeless tire 20 is mounted on the rim 10. Thus, the external face 26 of each of the annular walls 22 of the tubeless tire 20 is in air-tight contact with the internal face 16 of a corresponding one of the annular walls 12 of the rim 10. Particularly, the external face 26 of each annular wall 22 of the tubeless tire 20 is bit by the annular ribs 18 of the annular wall 12 of the rim 10.

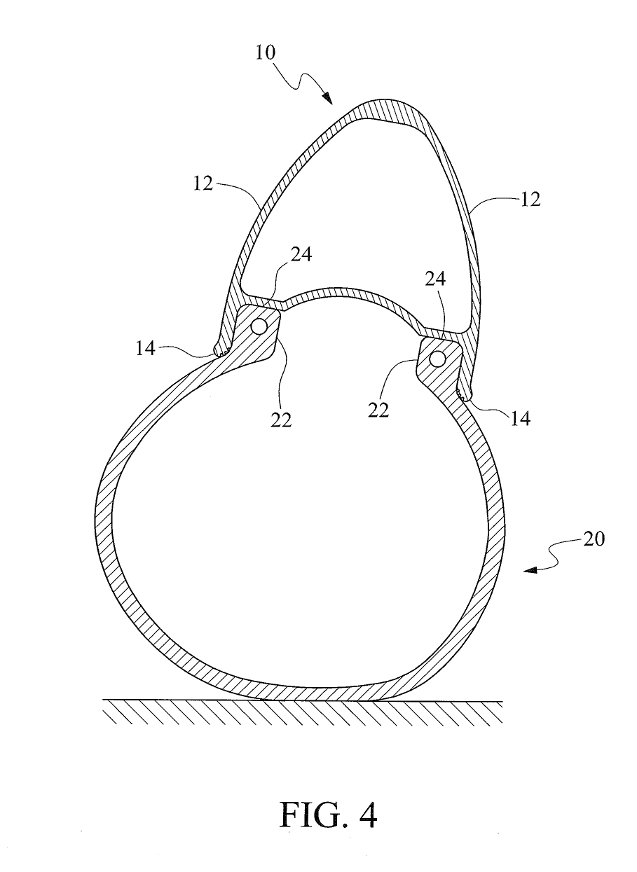

Referring to FIG. 4, the tubeless tire 20 and the rim 10 are tilted as a rider turns left or right on a bicycle equipped with the tubeless tire 20 and the rim 10. The internal face 26 of one annular wall 22 (the “first annular wall 22”) of the tubeless tire 20 is pushed harder against the internal face 16 of the corresponding annular wall 12 (the “first annular wall 12”) of the rim 10. There is however a tendency of the internal face 26 of the other annular wall 22 (the “second annular wall 22”) of the tubeless tire 20 to break away from the internal face 16 of the corresponding annular wall 12 (the “second annular wall 12”) of the rim 10. Advantageously, the external face 26 of the second annular wall 22 of the tubeless tire 20 is bit by the annular ribs 18 of the second annular wall 12 of the rim 10. Hence, the tubeless tire 20 is firmly kept on the rim 10.

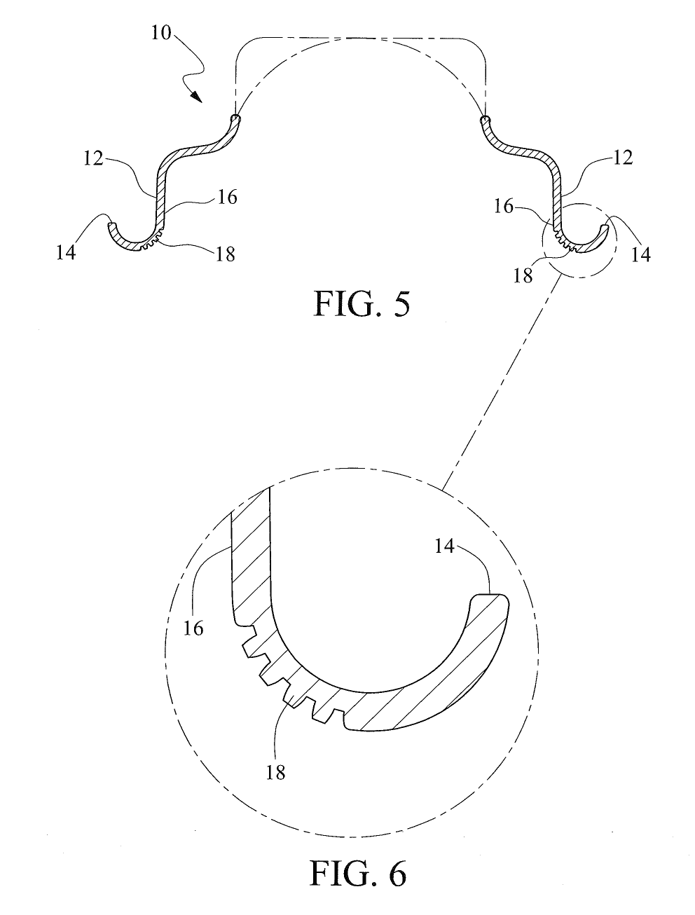

Referring to FIGS. 5 and 6, there is a rim 10 according to a second embodiment of the present invention. The second embodiment is like the first embodiment except a different shape and material. The edges 14 of the annular walls 12 of the rim 10 expand further from each other in the second embodiment than in the first embodiment. The second embodiment is generally made of iron while the first embodiment is generally made of aluminum.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A rim includes two annular walls 12 each including an edge 14, an internal face 16, and at least one rib 18 extending on the internal face 16 near the edge 14, wherein the rib 18 of each of the annular walls 12 of the rim bites an external face of a corresponding annular wall 26 of a tubeless tire 20 when the tubeless tire 20 is mounted on the rim.

2. The rim according to claim 1, wherein the rib 18 extends in an annular manner.

3. The rim according to claim 1, wherein each of the annular walls 12 includes a plurality of ribs 18 on the internal face 16.
